(19) United States
(12) Patent Application Publication
(10) Pub. No.: US 2026/0034715 A1
(43) Pub. Date: Feb. 5, 2026

(54) EXTRUDER SCREW

(71) Applicant: LEISTRITZ EXTRUSIONSTECHNIK GMBH, Nürnberg (DE)

(72) Inventor: Frank RECHTER, Uffenheim OT Welbhausen (DE)

(21) Appl. No.: 19/269,471

(22) Filed: Jul. 15, 2025

(30) Foreign Application Priority Data
Aug. 1, 2024 (DE) 10 2024 121 963.7

(51) Int. Cl. B29C 48/505; B21H 5/00; B29C 48/56; B29C 48/59

(52) U.S. Cl. CPC B29C 48/507; B21H 5/00; B29C 48/56; B29C 48/59

(57) ABSTRACT

An extruder screw having a worm shaft and a plurality of screw elements that are releasably plugged or pluggable thereon, wherein each screw element has a defined axial minimum length or a length that corresponds to a multiple of the minimum length. The worm shaft has an external toothing and the screw elements have an internal toothing engaging therewith. The external toothing has, forming individual gear rings extending around the circumference, a plurality of recesses extending around the circumference in an offset manner along its axial length, which are spaced apart from one another by the minimum length, such that the internal toothing of each screw element extends, at both axial ends, into the region of the recess, and the ends of the internal toothing are not engaged with the external toothing.

### CROSS-REFERENCE TO RELATED APPLICATIONS

The present application claims priority of DE 10 2024 121 963.7, filed Aug. 1, 2024, the priority of this application is hereby claimed, and this application is incorporated herein by reference.

### BACKGROUND OF THE INVENTION

The invention relates to an extruder screw consisting of a worm shaft and a plurality of screw elements that are releasably plugged or pluggable thereon, wherein each screw element has a defined axial minimum length or a length that corresponds to a multiple of the minimum length, wherein the worm shaft has an external toothing and the screw elements have an internal toothing engaging therewith.

Such extruder screws are known and allow a variable construction of an extruder screw in that, depending on the requirements, different screw elements, be they conveying, kneading or mixing elements, can be arranged in different orders on the worm shaft. In order to allow both the attachment of and the torque transmission, required during operation, from the worm gear, into which the torque is introduced via an extruder motor, to the screw elements, a shaft-hub toothing is provided between the worm shaft and the screw elements, meaning that the worm shaft has an external toothing, while the worm elements, acting as a hub, have an internal toothing on the inner side of their bore, wherein the two toothings mesh with one another. Usually, shaft-hub connections according to the standards DIN 5480, DIN 5464 or ISO 4156 in the form of an involute toothing are used in extruder screws. This form-fitting, symmetric toothing allows considerable torque transmission while, at the same time, the screw elements are easy to fit and remove.

On account of the high torque that is transmitted, the toothing is exposed to high loading, which can result, in particular in the case of an overload, in plastic deformation of the toothing, this not being desired. In particular, the hub edges are damaged in this case, since high stress peaks arise there on account of the stiffness discontinuity within the connection. These stress peaks can arise at both flanks of the hub toothing, resulting from different torsional stiffnesses between the worm shaft and the individual screw element. This difference in stiffness has the result that both the front flank and the rear flank of the hub toothing bear on the shaft toothing. Attempts have been made to counter this by providing the flanks of the inner toothing of the hub with a bevel axially on both sides, but this is very complicated since it has to take place as part of a separating finishing process. Usually, the inner toothing of a screw element is broached, wherein the broaching method allows only the formation of axially rectilinear flanks.

### SUMMARY OF THE INVENTION

The invention addresses the problem of specifying an improved extruder screw.

To solve the problem, the invention provides, in an extruder screw of the type mentioned at the beginning, that the external toothing has, forming individual gear rings extending around the circumference, a plurality of recesses extending around the circumference in an offset manner along its axial length, which are spaced apart from one another by the minimum length, such that the internal toothing of each screw element extends, at both axial ends, into the region of the recess, and the ends of the internal toothing are not engaged with the external toothing.

According to the invention, the extruder screw is formed with a multiplicity of separate recesses extending around the circumference, resulting in a corresponding number of separate gear rings extending around the circumference, which are formed from corresponding individual teeth or external toothing portions. The recesses and gear rings are, as seen axially, formed in a manner alternating with one another, wherein the axial spacing is defined in accordance with a predefined pattern. The recesses are spaced apart by a minimum length, meaning that the axial centers of the recesses, which are symmetric as seen perpendicularly to the shaft longitudinal axis, are all spaced apart from one another by the minimum length. This minimum length corresponds to the axial minimum length of a screw element that is able to be pushed onto the extruder shaft. As stated, the screw elements, as seen axially, either have only the minimum length or a multiple of this minimum length, i.e., for example, twice or three times the minimum length. The recesses and accordingly also synonymously the gear rings are formed in a manner spaced apart axially from one another along the worm shaft by precisely this minimum length pattern. If, for example, the minimum length is 30 mm, the recesses are formed symmetrically with this 30 mm pattern along the worm shaft. This also means, however, that the length of each ring gear, i.e. the axial length of the teeth or external toothing portions or the flanks thereof, located within the ring gear, is shorter than the defined pattern, i.e., for example, the 30 mm pattern. As a result, although each screw element pushed onto the worm shaft has its internal toothing meshing with the external toothing of a ring gear (or, in the case of a worm shaft with twice or three times the minimum length, with a plurality of ring gears), the internal toothing is not engaged with the external toothing at the two axial ends, since these axial ends are located in the region of a recess. The toothing engagement therefore does not occur along the entire length of the internal toothing of a screw element, but only in portions, defined along the length of the supporting external toothing within the individual ring gear.

This toothing engagement taking place in an axially offset manner from the respective front edge advantageously has the effect that the actual introduction of torque from the worm shaft into the screw element only takes place at a certain distance from the nub edge. The torque is thus introduced, as it were, in the “element interior”, having the result that, in the region of the front edges, i.e. at the ends of the internal toothing, any stress peaks can be reduced. The loading on the toothing ends can consequently be reduced, this in turn making it possible to increase the torque transmission as a whole, resulting from the as it were more “gentle”, locally limited introduction of torque, since, at the hub ends, no excess stress in conjunction with plastic deformation needs to be worried about.

Accordingly, each recess removes the respective end of the internal toothing of a screw element at the hub edge from toothing engagement. Since the teeth of the internal toothing have a corresponding radial length such that they extend deeply into the groove between two teeth of the external toothing, it is expedient for the recess to extend at most as far as the core of the worm shaft. This ensures that the ends of the internal toothing definitively cannot be engaged with the external toothing, even in the event of any torsions or other load-related changes in geometry.

As regards the formation of each recess, various possibilities are conceivable. The recess may, for example, have or be formed by a simple relief groove via which the external toothing is subdivided into the ring gears. This relief groove may, however, also form only a portion of the recess, meaning that the recess has a recess portion formed via the relief groove, which, as seen axially, is provided, for example, centrally in the recess formed. The relief groove has, for example, a length of 2-5 mm and may extend, for example, as far as the core of the worm shaft.

It is particularly advantageous for the external toothing to have, between two recesses, a central toothing portion with a maximum height, which is adjoined in both axial directions by a lateral toothing portion in which the height is reduced, forming the recess. The recess is accordingly not formed abruptly, for example via a relief groove with a corresponding sharp ring gear edge, but via a gradually reducing tooth height of the external toothing. The external toothing has a central toothing portion in which, as seen radially, there is maximum toothing engagement with the internal toothing. To both axial sides of this central toothing portion, the height of the external toothing then reduces such that the engagement height with the internal toothing is reduced, and also, at the end of this narrowing of the external toothing height, the internal toothing is no longer engaged with the external toothing.

In this case, the height can decrease linearly, i.e. the external toothing can have a ramp-like drop in height. It can thus, for example, drop via a sloping ramp with a constant angle from the maximum toothing height to the minimum toothing height, for example onto the core of the shaft, or run into a relief groove. Rather than such a linear height decrease, it is also conceivable for the tooth height to decrease, for example, convexly, i.e. to be reduced with a slight outward curvature, or to decrease in a wave-like manner, i.e. to have a convex portion followed by a concave portion, which then ends, for example, in a flat manner in the relief groove, or the like. Thus, different tooth and therefore ring gear geometries are conceivable, via which the height of the external toothing can be reduced, forming the recess.

As described above, during operation, as a result of the high torque to be transmitted, a certain elastic torsion of the shaft along its length occurs, having the result that both the front and the rear flank of each tooth of the internal toothing come into contact with the external toothing. In order to allow the best-possible bearing of the internal toothing on the external toothing in the region of the recess, where, as described, there is still toothing contact with the internal toothing along a certain length, an expedient development of the invention provides that the lateral toothing portions have rounded or sloping tooth flanks on one side or on both sides. In other words, the external toothing portions within the respective ring gear are slightly rounded or beveled on one or both sides, as seen in the circumferential direction, and so, in spite of a certain torsion of the shaft, very good bearing of the internal toothing occurs without excessive stress peaks. Consequently, an end relief is provided on the teeth of the external toothing. Since both the driving flank and the rear flank have a rounding or slope, the potential for torque transmission can be increased even further.

In this case, it is particularly expedient for the rounding or the slope of the tooth flanks to be formed so as to correspond to an expected torsional angle of the worm shaft during operation. This means that the roundings or slopes are not symmetric at the front and rear tooth flanks, but, as it were, asymmetric, taking into account a torsional angle to be set as expected during operation, which, as seen locally along the length of such a gear ring, is designed, amounts to a few seconds to minutes. This makes it possible for the internal toothing of the screw element to bear in the best-possible manner on the external toothing, which changes somewhat in terms of its geometry for torsion-related reasons, under torsional loading.

As described above, each recess can also have a recess portion in the form of a relief groove. If such a relief groove is provided, the recess portions that are formed within each gear ring by the reduction in the tooth height on both sides, taper off in the relief groove, i.e. end in the latter, wherein the relief groove, for example, as described, extends down to the core of the worm shaft.

An expedient development of the invention provides that the height of the internal toothing is reduced at both axial ends. Accordingly, the internal toothing thus also has a reduced height only immediately in the region of the two axial toothing ends, i.e. at the transition to the hub edge. This advantageously avoids a situation in which, in the event of any, even if minimal, tilting of a screw element, no indentations into the worm shaft occur via the internal toothing, since the internal toothing does not have a sharp toothing edge at its axial ends. Preferably, the height is reduced via a rounding, but a bevel would also be conceivable, wherein both the rounding and the bevel, as seen axially, should be as short as possible, since they serve merely to avoid indentations.

According to the invention, the external toothing and the internal toothing are preferably symmetric toothings, i.e. each have, on both sides, an identical flank angle or an identical flank geometry. The toothing may be embodied, for example, on the basis of DIN5480, a common toothing geometry in the field of extruder screws. However, trochoidal toothings, for example, are also conceivable, and it is possible, in principle, for any symmetric toothing to be used.

Preferably, the ring gears and the toothings have been produced without cutting. The external toothing and the ring gears are thus not machined using a broaching tool or a milling tool or the like, but are produced without cutting, for example by rolling. To this end, a corresponding profile rolling tool can be used, which has a transformational geometry which, to form a ring gear and the recess portions that are adjacent on both sides, is rolled into the cold-formable worm shaft. Such a tool can form, for example, a ring gear and the corresponding recess portions axially on both sides, such that, to produce a worm shaft with a corresponding number of ring gears, the worm shaft is successively moved axially by the corresponding number relative to the positionally fixed tool, which thus incrementally rolls a ring gear with an associated recess successively. Of course, it is alternatively also possible for the tool to be moved axially.

In addition to the extruder screw itself, the invention also relates to an extruder comprising one or more extruder screws of the above-described type.

When use is made of two or more extruder screws, these can preferably rotate in the same direction, but rotation in opposite directions is also conceivable.

Furthermore, the invention relates to a method for producing a worm shaft for an extruder screw of the above-described type. This method is characterized in that the external toothing is rolled without cutting on a shaft body by means of a profile rolling tool, wherein the gear rings and the associated recess portions are produced successively by axially moving the shaft body relative to the profile rolling tool. The method thus provides non-cutting rolling of the shaft body by means of the profile rolling tool. While it is, of course, possible to form only one ring gear with recess portions on both sides per axial position with the profile rolling tool, it is, of course, also conceivable, with a correspondingly longer design of the profile rolling tool, to form two or more ring gears with the corresponding recess portions etc. at an axial position of the workpiece processing process.

The shaft body itself consists preferably of a cold-formable material which is thermally treated after the formation of the gear rings in order to be hardened. The treatment takes place preferably by ageing, resulting in a considerable increase in strength, which is necessary for transmission of the high torques. The material is thus a precipitation hardenable steel, which is corrosion resistant and, because it is only solution annealed, is both cold-formable and can be hardened by ageing at a moderate ageing temperature in the range of 400-600° C., wherein the hardness should be, for example, between 40-55 HRC after ageing.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawings:

FIG. 1 shows a schematic illustration of a worm shaft of an extruder screw according to the invention,

FIG. 2 shows a schematic illustration of an extruder screw according to the invention with a worm shaft according to FIG. 1,

FIG. 3 shows an enlarged partial view of the worm shaft from FIG. 1, illustrating a ring gear with associated recesses,

FIG. 4 shows an enlarged partial view of the extruder screw according to the invention, illustrating the reduced-height internal toothing, and

FIG. 5 shows a schematic illustration of a second embodiment of an extruder screw according to the invention.

### DETAILED DESCRIPTION OF THE INVENTION

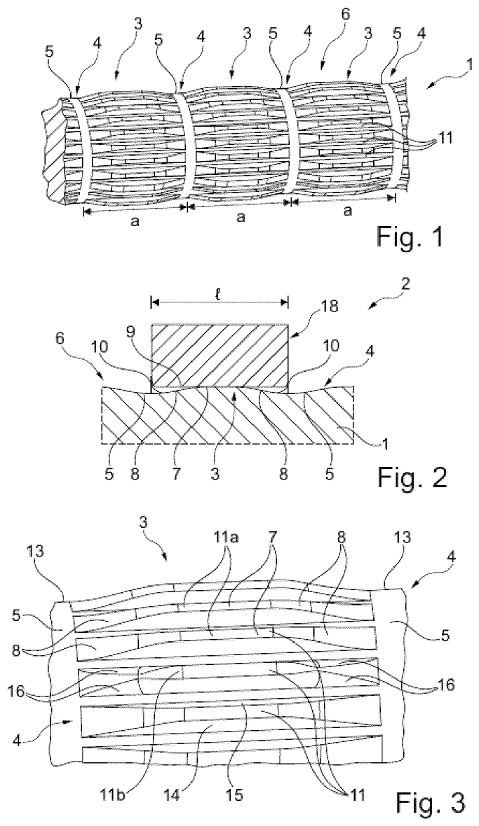

FIG. 1 shows a worm shaft 1, which is equipped for an extruder screw 2 according to the invention, as shown in FIG. 2. The worm shaft 1 has, distributed along its length, a plurality of ring gears 3 that are spaced apart axially from one another with a defined spacing pattern a, wherein, between each ring gear 3, a recess 4 is provided, which extends into the respective ring gear 3. Each ring gear 3 consists of a plurality of individual teeth 11, which form the ring gear in the circumferential direction. As is already shown in FIG. 1, the height of the respective teeth 11 decreases towards their two axial ends, as is described in more detail with reference to FIG. 3. In any case, the respective recess 4 is formed via this height reduction in conjunction with a relief groove 5 located between the ring gears 3. As a result of the defined pattern a, which corresponds exactly to an axial minimum length of a screw element which is pushed onto the worm shaft 1, there is a defined toothing geometry on the part of the external toothing 6, wherein the external toothing 6, as seen axially, is formed via the multiplicity of individual ring gears 3.

FIG. 2 shows a schematic illustration of an extruder screw 2 according to the invention, consisting of the worm shaft 1 and, in the example shown, a pushed-on screw element 18, wherein a multiplicity of such screw elements 18 are, of course, provided on the fully configured extruder screw.

The sectional view shows the external toothing 6 and, respectively, a ring gear 3, which clearly has a central toothing portion 7 in which the tooth height is constant, wherein this central toothing portion is adjoined on its two sides by two lateral toothing portions 8, in which, as FIG. 2 shows, the tooth height decreases, forming the recess 4. The toothing portions 8, the height of rich decreases, in the example, in a ramp-like manner, i.e. linearly, taper off in the relief groove 5, as FIG. 2 clearly shows.

The screw element 18—this being the case, of course, for each screw element 18 that is pushed onto the worm shaft 1—has an internal toothing 9, which meshes with the external toothing 6. The internal toothing 9 extends from one hub edge 10 to the other hub edge 10, i.e. virtually along the entire axial length of the screw element 18. The screw element 18 shown here has the minimum length l, i.e. the internal toothing 9 either corresponds to this minimum length l or, as is assumed in the following text, has a slightly reduced height at the two hub edges 10.

In any case, FIG. 2 clearly shows that the internal toothing 9 is engaged fully with the ring gear 3 or the teeth 11, respectively, only in the region of the central toothing portion 7. The engagement height reduces in the lateral toothing portions 8, since these have a reduced height. As FIG. 2 shows, the two axial ends of the internal toothing 9, i.e. the toothing portions of the internal toothing 9 in the region of the hub edges 10, are no longer engaged with the external toothing 6 or the ring gear 3, respectively, but lie in a non-load-bearing manner in the recess 4 and, in the present case, in the region of the respective relief groove 5. Torque transmission thus does not occur at the hub edges 10, since there is no torque-transmitting toothing connection there. Rather, the tooth engagement increases gradually with increasing height of the external toothing in the region of the lateral toothing portions 8, until the maximum tooth engagement exists between the internal toothing 9 and the external toothing 6 in the region of the central toothing portions 7. The maximum torque transmission occurs there. Since the hub edges 10 are not involved in torque transmission, no stress peaks can arise there, which, in the event of excessive load, can result in plastic deformation of the internal toothing in the region of the hub edges 10.

The ring gears 3 with the recesses 4 are, as stated, arranged in a defined pattern a and spaced apart axially from one another. This pattern a corresponds exactly to the minimum length l of a screw element 18. This ensures that each pushed-on screw element 18, whether this has only the minimum length l or a multiple n of the minimum length l (total length=n·l), is always received with the respective hub edges 10 in the region of a recess 4, and accordingly is not in tooth engagement with the external toothing in the region of the hub edges 10.

FIG. 3 shows an enlarged partial view of a ring gear 3. This consists of a multiplicity of individual teeth 11, wherein each tooth 11 has a central toothing portion 7 in which the respective tooth 11 has the maximum toothing height, while the two sides of the central toothing portion 7 are adjoined by two lateral toothing portions 8 in which the toothing height decreases down the core 13 of the worm shaft 6, to which the relief groove 5 of the respective recess 4 extends. The lateral toothing portions 8 extend in a ramp-like manner, i.e. their height decreases linearly from the maximum height in the toothing portion 7 and taper off in the respective relief groove 5. Rather than a linearly decreasing ramp-shape, however, a convex or wave-like geometry would also be conceivable. Clearly, the area of the respective front tooth flanks 14 and of the rear tooth flanks 15 thus also varies, as is shown in FIG. 3, such that the contact area between the external toothing 6 and the internal toothing 9 is inevitably accordingly formed such that it increases, as seen locally, gradually into the central toothing portion 7.

FIG. 3 shows, by way of example, teeth 11a in which the tooth flanks 14, 15 are planar until they taper off in the relief groove 5. In addition, purely for illustrative purposes, a tooth 11b is also shown, by way of example, in which the two tooth flanks 14, 15 have roundings 16 at their ends, i.e. in the region of the lateral toothing portions 8, i.e. are not planar. Via these roundings, the region in which there is a gradual increase of the contact area between the internal toothing 9 and the respective tooth 11b can additionally be optimized, i.e. gentle contact in the case of torque transmission can be brought about. This is the case in particular when the regions with the roundings 16 are designed taking into account a torsional angle arising under load, i.e. twisting of the worm shaft 1 about its longitudinal axis. The roundings 16 are thus not symmetric at the front and rear flanks 14, 15, but asymmetric, since the individual teeth 11b extend in an angled manner at least corresponding to the torsional angle, i.e. extend at least in an inclined manner with respect to the longitudinal axis. The configuration of the roundings 16 (rather than roundings, planar slopes can also be provided) can include this torsional angle, such that, under load, optimal contact results between the internal toothing 9 and the respective ring gear 3 or the correspondingly designed teeth 11b. Of course, either only teeth 11a, forming a ring gear 3, are provided, or only teeth 11b, but not corresponding mixed forms.

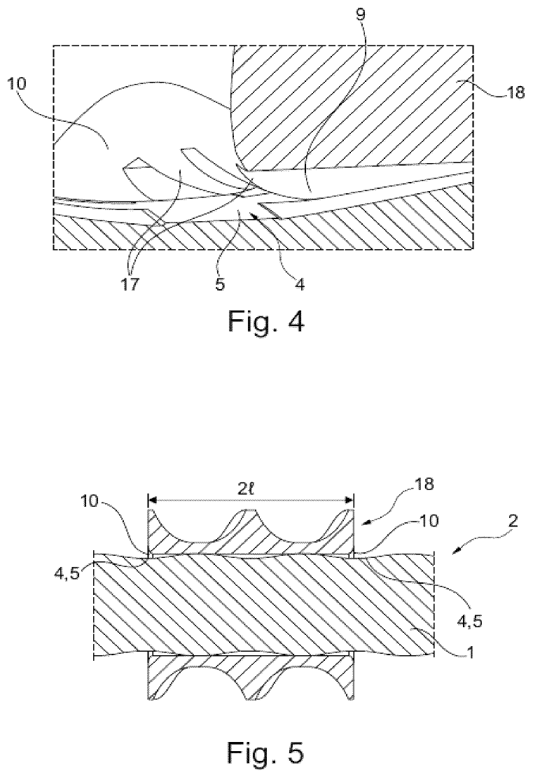

FIG. 4 shows an enlarged partial view of the region of the hub edge 10 of a screw element 18. What is shown is the internal toothing 9, which clearly has a reduced height in the region of the hub edge 10, wherein, to this end, corresponding roundings 17 (rather than a rounding, a bevel can also be provided) are provided at the axial ends of the internal toothing 9, wherein these roundings 17 are provided, of course, at both axial ends of the internal toothing. As FIG. 4 shows, these axial ends or roundings 17 are located in the region of the respective recess 4 or of the relief groove 5. If minimal tilting of a screw element 7 transversely to the longitudinal axis of the worm shaft 2 should occur under load, these roundings 17 make it possible to avoid a situation in which the hub edge is indented into the worm shaft.

Finally, FIG. 5 shows a configuration of an extruder screw 2 according to the invention, again comprising a worm shaft 1 according to the invention as shown in FIG. 1. The screw element 18 shown here has a length which corresponds, for example, to twice the minimum length l, as illustrated. Clearly, in the case of this screw element 18 that is twice as long, the hub edges 10 and the axial ends, located in the region thereof, of the internal toothing 9 are located in the region of the recess 4, or of the relief groove 5, such that, even in the case of such a screw element 7 that is twice as long, the internal toothing is not included in torque transmission in the region of the hub edges 10. The same also goes for even longer screw elements 18, which each measure a multiple of the minimum length l.

In order to ensure that each screw element 7 is arranged in a defined axial position, a correspond stop is, of course, provided on the worm shaft 1, against which the first screw element runs. Via this stop, it is positioned exactly with regard to the pattern a, such that each following screw element is likewise positioned exactly with regard to the pattern a, thereby ensuring that each hub edge 10 and thus also the respective end of the internal toothing 9 is arranged in the region of a recess 4, or of a relief groove 5, and is thus free of load.

The ring gear profile of the worm shaft 1 is formed preferably by rolling using a profile rolling tool, with which the corresponding contour of the external toothing 6 and the ring gears 3, in addition to the recesses 4, are rolled into the metal material of an as yet unformed shaft body. The material used for the worm shaft 1 is preferably a cold-formable steel, which, in the cold state, can be processed as appropriate with a profile rolling tool, and which, as a result of a downstream thermal treatment, in particular simple ageing, can be hardened as appropriate at least in the region of the external toothing 6, such that the required hardness values are achieved in the region of the external toothing 6.

While specific embodiments of the invention have been shown and described in detail to illustrate the inventive principles, it will be understood that the invention may be embodied otherwise without departing from such principles.

I claim:

1. An extruder screw comprising a worm shaft and a plurality of screw elements that are releasably plugged or pluggable thereon, wherein each screw element has a defined axial minimum length or a length that corresponds to a multiple of the minimum length, wherein the worm shaft has an external toothing and the screw elements have an internal toothing engaging therewith, characterized in that the external toothing has, forming individual gear rings extending around the circumference, a plurality of recesses extending around the circumference in an offset manner along its axial length, which are spaced apart from one another by the minimum length, such that the internal toothing of each screw element extends, at both axial ends, into the region of the recess, and the ends of the internal toothing are not engaged with the external toothing.

2. The extruder screw according to claim 1, wherein the recess extends as far as the core of the worm shaft.

3. The extruder screw according to claim 1, wherein the recess has a recess portion formed via a relief groove.

4. The extruder screw according to claim 1, wherein the external toothing has, between two recesses, a central toothing portion with a maximum height, which is adjoined in both axial directions by a lateral toothing portion in which the height is reduced, forming the recess.

5. The extruder screw according to claim 4, wherein the height decreases linearly or convexly or in a wave-like manner.

6. The extruder screw according to claim 4, wherein the lateral toothing portions have rounded or sloping tooth flanks on one side or on both sides.

7. The extruder screw according to claim 6, wherein the rounding or slope of the tooth flanks is formed so as to correspond to an expected torsional angle of the worm shaft during operation.

8. The extruder screw according to claim 4, wherein in each case two lateral toothing portions end in a relief groove.

9. The extruder screw according to claim 1, wherein the height of the internal toothing is reduced at both axial ends.

10. The extruder screw according to claim 9, wherein the height is reduced via a rounding or a bevel.

11. The extruder screw according to claim 1, wherein the external toothing and the internal toothing are symmetric toothings.

12. The extruder screw according to claim 1, wherein the external toothing and the recesses have been produced without cutting.

13. An extruder comprising one or more extruder screws according to claim 1.

14. The extruder screw according to claim 13, wherein when use is made of two or more extruder screws, the extruder screws rotate in the same direction or in opposite directions.

15. A method for producing a worm shaft for an extruder screw according to claim 1, wherein the external toothing is rolled without cutting on a shaft body by means of a profile rolling tool, wherein the gear rings and the associated recesses are produced successively by axially moving the shaft body relative to the profile rolling tool.

16. The method according to claim 15, wherein the shaft body consists of a cold-formable material which is thermally treated after the formation of the gear rings in order to be hardened.
